(19) United States
(12) Patent Application Publication
(10) Pub. No.: US 2004/0073425 A1
(43) Pub. Date: Apr. 15, 2004

(54) Arrangement for real-time automatic recognition of accented speech

(76) Inventors: Sharmistha Sarkar Das, Broomfield, CO (US); Richard A. Windhausen, Boulder, CO (US)

Correspondence Address: Docket Administrator (Room 1N-391), Avaya Inc., 307 Middletown-Lincroft Road, Lincroft, NJ, 07738, US

(21) Appl. No.: 10/269,725

(22) Filed: Oct. 11, 2002

(51) Int. Cl. G10L 15/12

(52) U.S. Cl. 704/236

(57) ABSTRACT

An automatic speech recognition (ASR) apparatus (100) has a database (108) of a plurality of clusters (110) of speech-recognition data each corresponding to a different accent and containing words and phonemes spoken with the corresponding accent, an accent identifier (104) that identifies the accent of incoming speech signals, and a speech recognizer that effects ASR of the speech signals by using the cluster that corresponds to the identified accent.

### TECHNICAL FIELD

This invention relates to automatic speech recognition.

### BACKGROUND OF THE INVENTION

Known automatic speech recognition (ASR) arrangements have limited capabilities of recognizing accented speech. This is mainly due to the fact that ASR requires large amounts of data to recognize accented speech. ASR usually has to be able to work in real time, but the larger is the recognition database, the more computation time is required to search this data for matches to the spoken words. Of course, one solution to the problem is to use a better, faster, search engine. This can be too expensive for many applications.

### SUMMARY OF THE INVENTION

This invention is directed to solving these and other problems and disadvantages of the prior art. Generally according to the invention, the ASR database is made up of a plurality of clusters, or sub-databases, of speech-recognition data, each corresponding to a different accent. Once the speaker's accent is identified, only the corresponding cluster is used for ASR. This greatly limits the amount of data that must be searched to perform ASR, thereby allowing recognition of accented speech in real time.

Specifically according to the invention, automatic speech recognition (ASR) of accented speech is effected as follows. The accent of speech is identified from signals representing the speech. The identified accent is used to select a corresponding one of a plurality of stored clusters of speech-recognition data, where each cluster corresponds to a different accent. The selected cluster is then used as the rules definition for ASR for the remaining duration of the session. Preferably, the other clusters are not used in executing ASR of these signals for the remaining duration of the session.

While the invention has been characterized in terms of method, it also encompasses apparatus that performs the method. The apparatus preferably includes an effector—any entity that effects the corresponding step, unlike a means—for each step. The invention is independent of implementation, whether in hardware or software, communication means, or system partitioning. The invention further encompasses any computer-readable medium containing instructions which, when executed in a computer, cause the computer to perform the method steps.

### BRIEF DESCRIPTION

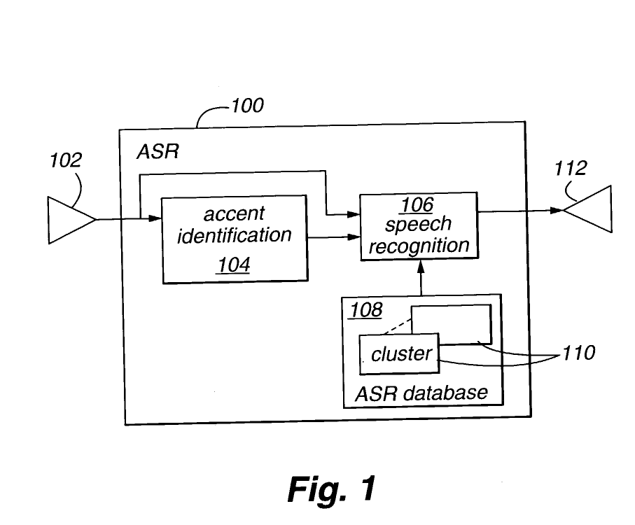

FIG. 1 is a block diagram of an automatic speech recognition (ASR) arrangement that includes an illustrative embodiment of the invention; and

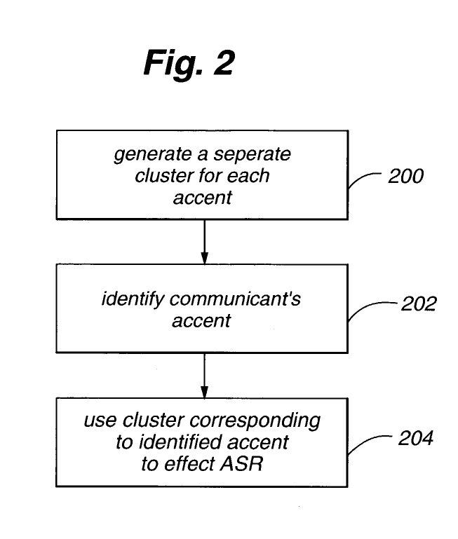

FIG. 2 is a flow diagram of functionality involved in the ASR arrangement of FIG. 1.

### DETAILED DESCRIPTION

FIG. 1 shows an automatic speech recognition (ASR) arrangement 100 that includes an illustrative embodiment of the invention. ASR arrangement 100 includes an ASR database 108 of words and phonemes that are used to effect ASR. Database 108 is divided into a plurality of clusters 110, each corresponding to a different accent. The data in each cluster 110 comprises words and phonemes that are characteristic of individuals who speak with the corresponding accent. Each cluster corresponds to an accent that may be representative of one or more languages or dialects. The term “language” will be used to refer to any language or dialect to which a specific grammar cluster applies. Database 108 may also include different sets of clusters 110 for different spoken languages, with each set comprising clusters for the corresponding language spoken with different accents. Each cluster set is used to recognize speech that is spoken in the corresponding language, and each cluster 110 is used to recognize speech that is spoken with the corresponding accent. Hence, only the corresponding cluster 110 and not the whole database 108 must be searched to perform ASR for a speaker who has a particular accent in a particular language.

ASR 100 has an input 102 of signals representing speech connected to accent identification 104 and speech recognition 106. Voice samples collected by input 102 from a communicant are analyzed by accent identification 104 to determine (classify) the communicant's accent, and optionally even the language that he or she is speaking. Language identification may be performed for the case when the speaker says some foreign words; then the system may switch to a database of ASR which has a mixture of language models, e.g., English and Spanish, or English and Romantic languages. Also, the same word or phoneme may appear with different meanings in several languages or accented versions of languages. Without a language context, accent identification 104 may switch to the wrong cluster. The analysis to determine accent is illustratively effected by comparing the collected voice sample to stored known speech samples. Illustrative techniques for accent or language identification are disclosed in L. M. Arslan, Foreign Accent Classification in American English, Department of Electrical and Computer Engineering Graduate School thesis, Duke University, Durham, N.C., USA (1996), L. M. Arslan et al., “Language Accent Classification in American English”, Duke University, Durham, N.C., USA, Technical Report RSPL-96-7, Speech Communication, Vol. 18(4), pp. 353-367 (June/July 1996), J. H. L. Hansen et al., “Foreign Accent Classification Using Source Generator Based Prosodic Features”, IEEE International Conference on Acoustics, Speech, and Signal Processing, 1995. ICASSP-95., Vol. 1, pp. 836-839, Detroit, Mich., USA (May 1995), and L. F. Lamel et al., “Language Identification Using Phone-based Acoustic Likelihoods”, IEEE International Conference on Acoustics, Speech, and Signal Processing, 1994. ICASSP-94., Vol. 1, pp. I/293-I/296, Adelaide, SA, AU (19-22 Apr. 1994).

When the accent or the language and accent is determined, accent identification 104 notifies speech recognition 106 thereof. Speech recognition 106 uses this information to select one cluster 110 from its ASR database 108 which corresponds to the identified accent. Speech recognition 106 then applies the speech signals incoming on input 102 to the selected cluster 110 to effect ASR in a conventional manner. The recognized words are output by speech recognition 106 on output 112 to, e.g., a call classifier.

ASR 100 is illustratively implemented in a microprocessor or a digital signal processor (DSP) wherein the data and programs for its constituent functions are stored in a memory of the microprocessor or the DSP or in any other suitable storage device. The stored programs and data are executed and used from the memory by the processor element of the DSP. An implementation can also be done entirely in hardware, without a program.

Functionality that is involved in ASR 100 is shown in FIG. 2. First, separate clusters 110 are generated for each accent of interest, at step 200, in a conventional manner, and the clusters are stored in ASR database 108. ASR 100 is now ready for use. Accent identification 104 identifies the accent of a communicant whose speech is incoming on input 102, at step 202, and notifies speech recognition 106 thereof. Speech recognition 106 then uses the identified accent's corresponding cluster 110 to effect ASR, at step 204, and sends the result out on output 112.

Of course, various changes and modifications to the illustrative embodiment described above will be apparent to those skilled in the art. For example, different methods from the ones described can be used to identify accents. Different ways can be used to group or organize clusters or sets of clusters. Different connectivity can be employed between the elements of the ASR (e.g., accent identification communicating directly with the ASR database), and elements of ASR can be combined or subdivided as desired. Also, multiple instantiations of one or more elements of ASR, or of the ASR itself, may be used. Such changes and modifications can be made without departing from the spirit and the scope of the invention and without diminishing its attendant advantages. It is therefore intended that such changes and modifications be covered by the following claims except insofar as limited by the prior art.

What is claimed is:

1. A method of effecting accented-speech recognition, comprising:
identifying an accent of speech from signals representing the speech;
using the identified accent to select a corresponding one of a plurality of stored clusters of speech-recognition data, each cluster corresponding to a different accent; and
using the selected cluster to effect automatic speech recognition of the signals.

2. The method of claim 1 wherein:
using the selected cluster comprises refraining from using other said clusters to effect the automatic speech recognition of the signals.

3. The method of claim 1 wherein:
each cluster comprises words and phonemes of a same one language spoken with the corresponding accent.

4. An apparatus that performs the method of claim 1.

5. The apparatus of claim 4 that further refrains from using other said clusters to effect the automatic speech recognition of the signals.

6. The apparatus of claim 4 further comprising:
a store for storing the plurality of clusters.

7. The apparatus of claim 6 wherein:
each cluster comprises words and phonemes of a same one language spoken with the corresponding accent.

8. A computer-readable medium containing executable instructions which, when executed in a computer, cause the computer to perform the method of claim 1.

9. The medium of claim 8 further containing instructions that cause the computer to refrain from using other said clusters to effect the automatic speech recognition of the signals.

10. The medium of claim 8 further containing the plurality of stored clusters.

11. The medium of claim 10 wherein:
each cluster comprises words and phonemes of a same one language spoken with the corresponding accent.

12. An apparatus for effecting accented-speech recognition, comprising:
a database storing a plurality of clusters of speech-recognition data, each cluster corresponding to a different accent;
an accent identifier that identifies an accent of speech from signals representing the speech; and
a speech recognizer that responds to identification of the accent by the accent identifier by using the cluster corresponding to the identified accent to effect automatic speech recognition of the signals.

13. The apparatus of claim 12 wherein:
the speech recognizer refrains from using other said clusters to effect the automatic speech recognition of the signals.

14. The apparatus of claim 12 wherein:
each cluster comprises words and phonemes of a same one language spoken with the corresponding accent.
